(19) United States
(12) Patent Application Publication
(10) Pub. No.: US 2018/0356693 A1
(43) Pub. Date: Dec. 13, 2018

(54) LIQUID CRYSTAL DISPLAY DEVICE

(71) Applicant: Japan Display Inc., Minato-ku (JP)

(72) Inventor: Osamu ITOU, Minato-ku (JP)

(73) Assignee: Japan Display Inc., Minato-ku (JP)

(21) Appl. No.: 15/995,329

(22) Filed: Jun. 1, 2018

(30) Foreign Application Priority Data
Jun. 7, 2017 (JP) 2017-112305

(51) Int. Cl. G02F 1/1343; G02F 1/1362; G02F 1/1368; G02F 1/1335

(52) U.S. Cl. CPC G02F 1/134309; G02F 1/136286; G02F 2001/134381; G02F 1/133512; G02F 1/133514; G02F 1/1368

(57) ABSTRACT

The purpose of the invention is to realize a liquid crystal display device of high definition and high response speed. The representative structure is: a liquid crystal display device comprising: a first substrate and a second substrate, which sandwiches a liquid crystal layer; the pixel includes: a thin film transistor, a first electrode, a second electrode formed over the first electrode sandwiching an insulating film, a contact hole that connects the second electrode and the thin film transistor, the second electrode has a first portion that extends in the second direction, and a second portion that is wider in the first direction than the first portion, a first projection extending in the second direction over the video signal line, and a second projection, which is wider than the first projection in the first direction, at the position aligned with the second portion in the first direction are formed.

### CLAIM OF PRIORITY

The present application claims priority from Japanese Patent Application JP 2017-112305 filed on Jun. 7, 2017, the content of which is hereby incorporated by reference into this application.

### BACKGROUND OF THE INVENTION

### (1) Field of the Invention

The present invention relates to a display device, specifically a high definition liquid crystal display device, which is used for a VR (virtual Reality) viewer etc.

### (2) Description of the Related Art

A liquid crystal display device has a TFT substrate, a counter substrate opposing to the TFT substrate, and a liquid crystal layer sandwiched between the TFT substrate and the counter substrate. The TFT substrate has plural pixels arranged in matrix form; each of the pixels has a pixel electrode and a thin film transistor (TFT). A transmittance of light in each of the pixel is controlled by liquid crystal molecules; thus, images are formed.

The liquid crystal display device has a problem in viewing angle characteristics. The IPS (In Plane Switching) type liquid crystal display device has superior characteristics in viewing angle characteristics. On the other hand, when the display becomes high definition, a transmittance of light in the pixel becomes a problem. Namely, the ratio of the area of the contact hole or video signal lines, etc. that doesn't contribute to formation of displays becomes relatively bigger in the pixel.

In addition, the IPS type liquid crystal display device has a problem in response speed. The response speed can be improved by making the liquid crystal molecules a splay bend deformation. The patent document 1 (Japanese patent 5937389) discloses to add splay bend deformation to the liquid crystal molecules by making the common electrode a specific structure in the IPS type liquid crystal display device.

In addition, in the liquid crystal display device, the domain is generated due to a reverse rotation of the liquid crystal molecules in certain places; the light doesn't transmit the boundary between the domain and the normal region, thus, the a generation of the domain further decreases the transmittance of the pixel. The patent document 2 (WO 2011/129191) discloses to set photo spacers at four corners of the pixel to regulate the directions of tilting of the liquid crystal molecules when the voltage is applied in VA (Vertical Alignment) type liquid crystal display device.

### SUMMARY OF THE INVENTION

A display device that has 1000 ppi definition, which is two times higher definition of current smart phone, is necessary to get a smooth display where individual pixels are not recognizable in the VR (virtual Reality) viewer. Such a high definition display can be more realistic to attain by the liquid crystal display device rather than by the organic EL display. The VR viewer mainly displays moving pictures, thus, response speed of 6 ms or less is required as well as high definition; however, the liquid crystal display device is inferior in response speed compared with the organic EL display, further the IPS type liquid crystal display device is rather inferior in response speed among several types of the liquid crystal display device.

The liquid crystal display device of IPS type uses twist deformation; one of the reasons of low response characteristics is low elastic constant of the twist deformation. The SLC (Short pitch Lurch Control) type improves response speed by using splay deformation, which has high elastic constant, however, if the splay deformation is combined in the IPS type liquid crystal display device, the splay deformation cannot be uniformly formed in the liquid crystal layer; thus, domains must be set periodically in the alignment. If the definition is low, the domain can be stabilized by setting a pair of the comb shaped electrodes in opposite with half pitch deviation; however, it is difficult to adopt the same structure in high definition of 1000 ppi because only one comb shaped electrode or slit can be formed in one pixel in such a high definition.

Since the viewing angle characteristics is important in smart phone that can also be used as VR viewer, it is necessary to make the IPS type have high definition and high response speed. On the other hand, if the domain boundary is formed in the pixel, the transmittance is decreased. Further, if the domain is not stabilized display unevenness is generated in the screen. The purpose of the present invention is to realize the pixel structure that can prevent a decrease in screen brightness and stabilize the domain by combining the IPS and the SLC in the super high definition LCD.

The present invention overcomes the above explained problem; the concrete measures are as follows.

(1) A liquid crystal display device comprising:

a first substrate having a plurality of scan lines extending in a first direction, a plurality of video signal lines extending in a second direction, which crosses the first direction, a pixel formed in an area surrounded by the video signal lines and the scan lines,

a second substrate opposing to the first substrate sandwiching a liquid crystal layer;

the pixel includes: a thin film transistor, a first electrode, a second electrode formed over the first electrode sandwiching an insulating film, a contact hole that connects the second electrode and the thin film transistor,

the second electrode has a first portion that extends in the second direction, and a second portion that is wider in the first direction than the first portion,

a first projection extending in the second direction over the video signal line, and

a second projection, which is wider than the first projection in the first direction, at the position aligned with the second portion in the first direction are formed.

(2) A liquid crystal display device comprising:

a first substrate having a plurality of scan lines extending in a first direction, a plurality of video signal lines extending in a second direction, which crosses the first direction, a pixel formed in an area surrounded by the video signal lines and the scan lines,

a second substrate opposing to the first substrate sandwiching a liquid crystal layer;

the pixel includes: a thin film transistor, a first electrode, a second electrode formed over the first electrode sandwiching an insulating film, a contact hole that connects the second electrode and the thin film transistor,

the first electrode is formed in plane shape, the second electrode has a slit,

the slit has a first portion that extends in the second direction, and a second portion that is wider in the first direction than the first portion,

a first projection extending in the second direction over the video signal line, and

a second projection, which is wider than the first projection in the first direction, at the position nearer to the contact hole are formed.

### BRIEF DESCRIPTION OF THE DRAWINGS

FIG. 1A is a perspective view of the liquid crystal display device according to the present invention;

FIG. 1B is a plan view that shows the structure of the second substrate;

FIG. 2 is a plan view of the pixel according to first embodiment;

FIG. 3A is an example of the pixel electrode;

FIG. 3B is another example of the pixel electrode;

FIG. 4A is a cross sectional view along A-A′ line of FIG. 2;

FIG. 4B is a cross sectional view along B-B′ line of FIG. 2;

FIG. 5A is a plan view that shows initial alignment of the liquid crystal;

FIG. 5B is a plan view that shows directions of the field when voltage is applied to the pixel electrode;

FIG. 5C is a plan view that shows alignment of the liquid crystal when the voltage is applied to the pixel electrode;

FIG. 5D is a plan view that shows polarizing direction of the ultra violet ray in the hemisphere model;

FIG. 5E is a perspective view when FIG. 5D is viewed in direction C;

FIG. 5F is a plan view that shows initial alignment direction of the liquid crystal after baking in the hemisphere model;

FIG. 5G is a perspective view when FIG. 5F is viewed in direction C;

FIG. 6A is a cross sectional view along A-A′ line of FIG. 2 according to another example;

FIG. 6B is a cross sectional view along A-A′ line of FIG. 2 according to yet another example;

FIG. 7A is a plan view of the electrode structures of the pixel according to another example;

FIG. 7B is a plan view of the directions of field when the voltage is applied to the pixel electrode and the alignment of the liquid crystal at the domain fixing projection in the structure of FIG. 7A;

FIG. 8A is a plan view of the pixel according to second embodiment;

FIG. 8B is a plan view of the pixel according to another example of second embodiment;

FIG. 9A is a cross sectional view along A-A′ line in FIG. 8A;

FIG. 9B is a cross sectional view along B-B′ line in FIG. 8A;

FIG. 10A is a plan view of the pixel according to another example of second embodiment;

FIG. 10B is a plan view of the pixel according to yet another example of second embodiment;

FIG. 11 is a plan view of the pixel according to further yet another example of second embodiment;

FIG. 12A is a cross sectional view along A-A′ line in FIG. 8A according to third embodiment;

FIG. 12B is a cross sectional view along B-B′ line in FIG. 8A according to third embodiment;

FIG. 13A is a cross sectional view along A-A′ line in FIG. 8A according to fourth embodiment;

FIG. 13B is a cross sectional view along B-B′ line in FIG. 8A according to fourth embodiment;

FIG. 14A is a plan view of the pixel according to fifth embodiment;

FIG. 14B is a plan view that shows the alignment of the liquid crystal when the voltage is applied to the pixel electrode according to fifth embodiment;

FIG. 15A is a plan view of the pixel according to sixth embodiment;

FIG. 15B is a plan view that shows alignment of the liquid crystal when the voltage is applied to the pixel electrode according to sixth embodiment;

FIG. 16A is a plan view of the pixel according to seventh embodiment;

FIG. 16B a plan view that shows the alignment of the liquid crystal and the domain when the voltage is applied to the pixel electrode according to seventh embodiment.

### DETAILED DESCRIPTION OF THE PREFERRED EMBODIMENTS

Since IPS (In Plane Switching) type liquid crystal display device has superior characteristics in viewing angle characteristics, ii is widely used in smart phone; however, its response speed is rather low among the liquid crystal display devices. One reason for low response in the IPS type liquid crystal display device is that it uses twist deformation of the liquid crystal layer in its behavior; the elastic constant of twist deformation is small.

The SLC type improves response speed by using splay deformation of the liquid crystal layer, which has a high elastic constant, however, if the SLC type is combined with the IPS type, splay deformations cannot be distributed in the liquid crystal layer uniformly; consequently, the domains, which are formed when voltages are applied, must be distributed periodically in the liquid crystal alignments. If the definition is low, the domain can be stabilized by setting a pair of the comb shaped electrodes in opposite with half pitch deviation; however, it is difficult to adopt the same structure in high definition of 1000 ppi because only one comb shaped electrode or slit can be formed in one pixel in such a high definition display.

In this specification, the domain boundary is defined as a dark portion where the rotations of the liquid crystal molecules are so slight that the change of transmittance is small; while the domain is defined as an area where the directions of the rotation of the liquid crystal molecules are the same and surrounded by the domain boundaries.

It is ideal if the smart phone is also used as a VR viewer; however, such a display must satisfy high definition and high response speed as well as maintaining wide viewing angle. The most realistic way to attain that display is to make the IPS type, which has superior viewing angle characteristics, high definition and high response speed. The present invention is for pixel structures that realize such requirements. The present invention is explained in detail in the following embodiments.

### First Embodiment

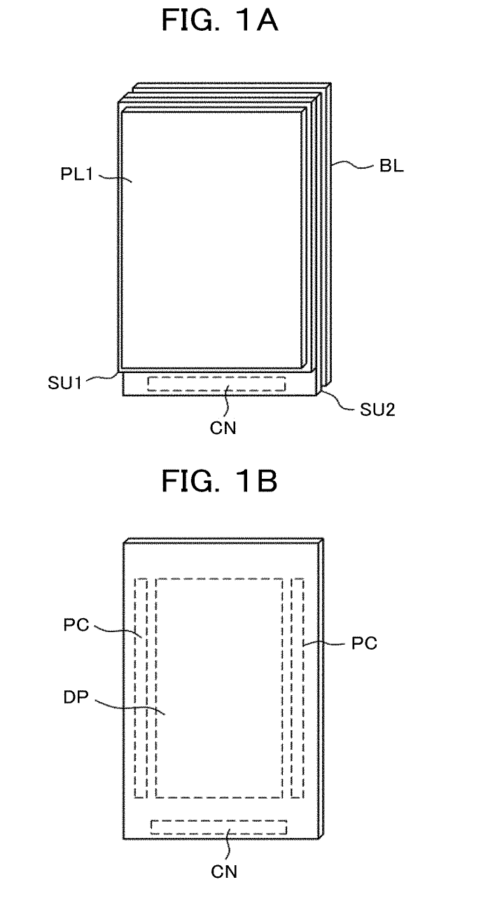

FIG. 1A is a perspective view that shows the structure of the liquid crystal display device; FIG. 1B is a plan view of the liquid crystal display device according to the present invention. As depicted in FIG. 1A, the first substrate SU1 and the second substrate SU2 sandwich the liquid crystal layer LC (see FIG. 3A); the backlight BL is disposed to on the back of the second substrate SU2. FIG. 1B is a plan view of the second substrate SU2 viewed from the side of the liquid crystal layer LC. The peripheral driving circuit PC and the connection portion CN are formed at outer side of the display area DP. The driving circuit is connected through the connection portion CN. The back light BL comprises a light guide and a light source LS; the light source LS is a structure that the phosphor is laminated over the blue light emitting diode, consequently, the light source emits white light; the light source is disposed on a side surface of the light guide.

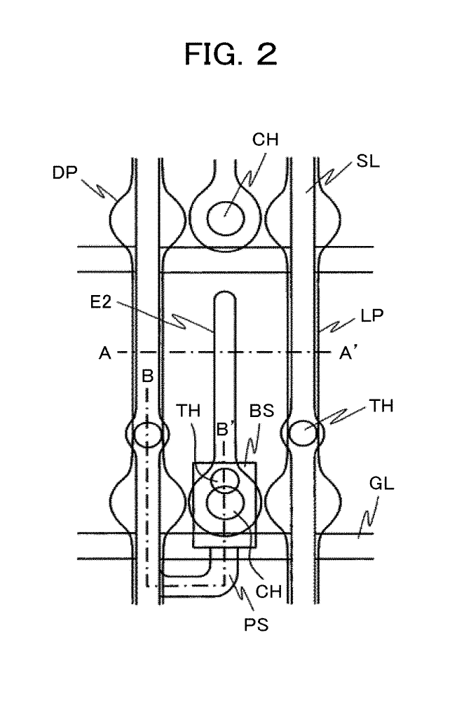

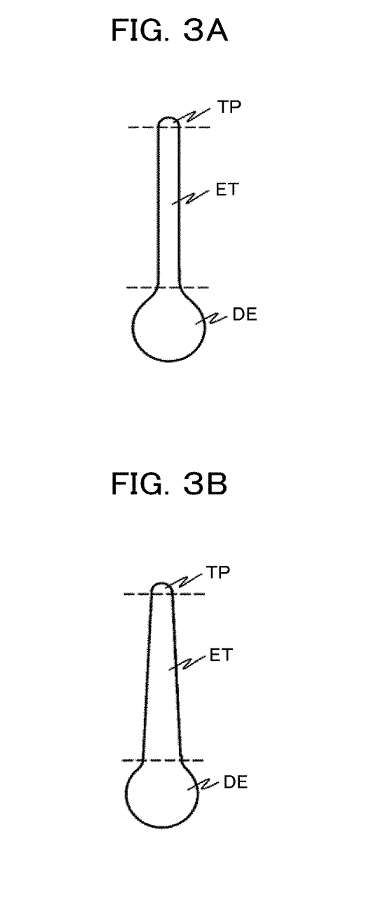

FIG. 2 is a plan view of the pixel of the liquid crystal display device according to the present invention. FIG. 2 includes one pixel and its surroundings; namely, plan views of the signal lines SL, the scan lines GL, the second electrode E2, the polysilicon layer PS, the pedestal layer BS, the contact hole CH, the through hole TH, the line shaped projections LP, and the domain fixing projections DP on the second substrate SU2.

The signal line SL and the scan line GL orthogonally cross to each other; the polysilicon layer PS exists at cross area of the signal line SL and the scan line GL; the polysilicon layer PS connects with the second electrode E2 via through hole TH, the pedestal layer BS and the contact hole CH. In the meantime, even the contact hole CH is multi holes formed in the second flattening film OC2, fourth insulating film IL4 and first electrode E1; the contact hole CH is represented by the hole formed in the fourth insulating film IL4.

The second electrode E2 is approximately line shaped and extends in parallel with the signal line SL. Provided a lattice formed by the signal lines SL the scan lines GL is one pixel, the second electrode E2 is in one pixel. The pitch of the signal line SL is 8.4 μm and the pitch of the scan line GL is 25.2 μm; corresponding definition is 1000 ppi.

FIG. 3A is an enlarged view of the second electrode E2. The second electrode E2 comprises the tip TP, extending portion ET and domain fixing structure DE; the domain fixing structure DE is wider than the extending portion ET and is approximately circle shaped in a plan view, and including the contact hole CH in its center concentric with the contact hole, which is inside of the domain fixing structure. The tip TP is located at opposite side of the extending portion ET from the domain fixing structure DE.

As depicted in FIG. 2, the line shaped projection LP is distributed on the signal line SL in line shaped; the domain fixing projection DP, which is circled shaped in a plan view, is located at the side of the domain fixing structure DE. The line shaped projection LP and the domain fixing projection DP are formed continuously. The second electrode E2 is most closed to the domain fixing projection DP at the domain fixing structure DE.

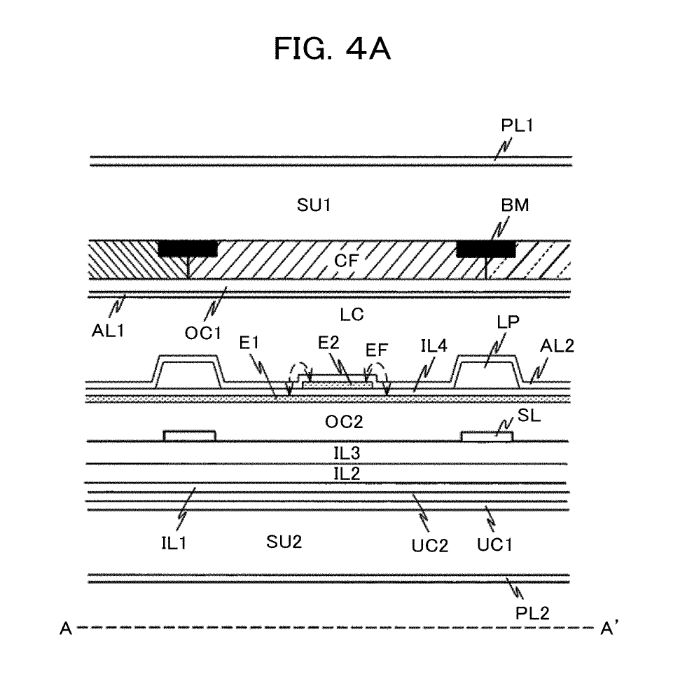

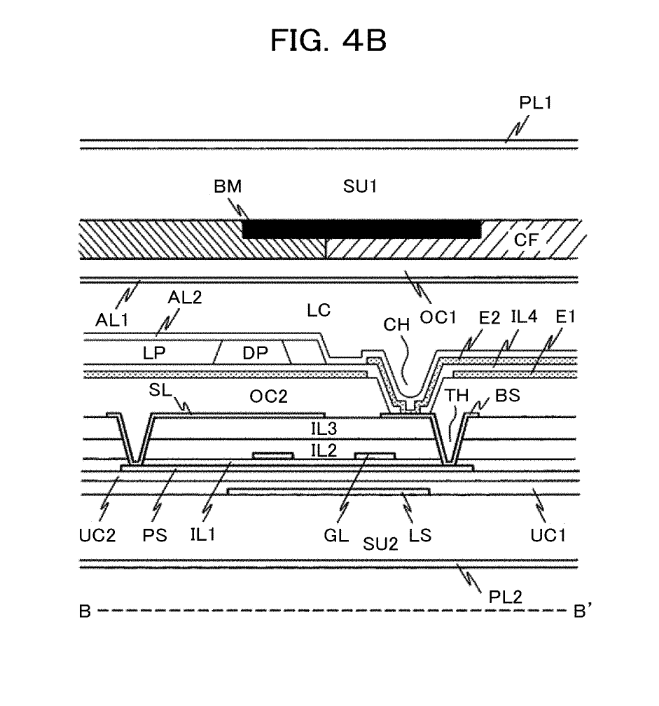

FIG. 4A is a cross section of A-A′ of FIG. 2 and FIG. 4B is a cross section of B-B′ of FIG. 2. FIG. 4A is a cross sectional view at the center of the pixel; FIG. 4B is a cross sectional view that includes the thin film transistor. The first substrate SU1 is borosilicate glass of a thickness of 0.2 mm. The first alignment film AL1, the spacer SS, the first flattening film OC1, the color filter CF, the black matrix BM are formed in this order from the liquid crystal layer LC side on the first substrate SU1.

The second substrate SU2 is borosilicate glass of a thickness of 0.2 mm like the first substrate Sill. On the second substrate SU2, the following layers are formed in the order from the liquid crystal layer LC side; namely, the second alignment film AL2, the line shaped projection LP, domain fixing projection DP, the second electrode E2, the fourth insulating film IL4, the first electrode E1, the second flattening film OC2, the pedestal layer BS, the signal line SL, the third insulating film IL3, the second insulating film IL2, the scan line GL, the first insulating film IL1, the polysilicon layer PS, the second undercoat UC2, the first undercoat UC1 and the light shield layer LS.

The first alignment film AL1 is a polyimide film that is processed by optical alignment method; the first flattening film OC1 is a non-optically sensitive transparent organic film of a thickness of 1 μm; the black matrix BM is formed by negative type resist of a thickness of 1.5 μm that includes black pigments. The color filter CF includes the red color filter RC, the green color filter GC and the blue color filter BC, which are repeated in certain spatial pitch.

The red color filter RC, the green color filter GC and the blue color filter BC are all plane and stipe shaped, and formed by negative type resist, wherein the red color filter RC contains red pigments, the green color filter contains green pigments and the blue color filter contains blue pigments; thickness of color filters are all 2.3 μm. By the way, the laminating order of the color filter CF, the black matrix BM, and the first flattening film OC1 on the first substrate is not necessarily in this order. For example, if the black matrix BM is formed nearer to the liquid crystal layer LC rather than the color filter CF, a color mixture due to the viewing angle can be decreased.

The second alignment film AL2 is a polyimide film of a thickness of 1.0 μm that is processed by optical alignment method, as the same as the first alignment film AL1. The line shaped projection LP and the domain fixing projection DP are made of light sensitive transparent organic film. The first electrode E1 and the second electrode E2 are formed by ITO (Indium Tin Oxide) at a thickness of 50 nm.

The second electrode E2, which connects with the polysilicon PS via the contact hole CH, the pedestal layer BS and the through hole TH, is supplied with the pixel voltage that corresponds to the video signal. The first electrode E1 is applied with common electrode via edge of the display area although it is not depicted. The fourth insulating film IL4 is a silicon nitride film that is formed by low temperature, the thickness is 70 nm; the overlapping portion with the first electrode E1 and the second electrode E2 constitutes the holding capacitance.

The second flattening layer OC2 is a positive type transparent resist of a thickness of 2.5 μm. The signal line SL, which is 1.5 μm width, is formed on the same layer as the pedestal layer BS; the signal line SL is formed by three layers of Titan (a thickness of 200 nm), Aluminum (including aluminum alloy) (a thickness of 450 nm), and Titan (a thickness of 100 nm). The pedestal layer BS is connected to the polysilicon layer PS via the through hole TH. The third insulating film IL3 is a silicon nitride film, the thickness is 350 nm. The second insulating film IL2 and the first insulating film IL1 are silicon oxide film, the thickness of the second insulating film IL2 is 350 nm and the thickness of the first insulating film IL2 is 100 nm.

The scan line GL, which is 3.0 μm width, and the light shield layer LS are both made of an alloy of Molybdenum and Tungsten, the thick ness of the scan line GL is 250 nm and the thickness of the light shield layer LS is 100 nm. Polysilicon layer PS is the polysilicon that is converted from the amorphous silicon by laser annealing; the thickness is 50 nm. The first undercoat UC1 is a silicon oxide film of a thickness of 150 nm, the second undercoat UC2 is a silicon nitride film of a thickness of 100 nm.

Although FIGS. 2, 4A and 4B do not show, post spacers are set at certain cross areas of the signal lines SL and the scan lines GL to hold the liquid crystal layer LC and to maintain the thickness of the liquid crystal layer uniform in the display area. The post spacers are columnar organic films that are formed on the first substrate SU1 or on the second substrate SU2.

The liquid crystal layer LC is formed by the material of positive dielectric anisotropy, which dielectric constant of the liquid crystal molecules in the alignment direction is bigger than that in the direction perpendicular to the alignment direction; the liquid crystal layer formed by the material of positive dielectric anisotropy has high electrical resistance and reveals nematic phase in a wide temperature range. The alignment state of the liquid crystal layer LC is homogeneous when no voltage is applied; the first alignment film AL1 and the second alignment film AL2 are optically aligned so that the liquid crystal molecules align parallel to the signal line SL. Namely, the polarized Ultra Violet ray (UV ray) is irradiated to the alignment films so that the vibration direction of the polarized UV ray is perpendicular to the signal line.

The first polarizing plate PL1 is set on the upper side of the first substrate SU1 and the second polarizing plate PL2 is set on the lower side of the second substrate SU2. The absorbing axis of the first polarizing plate PL1 and the absorbing axis of the second polarizing plate PL2 are on a plane perpendicular to the normal axis of the liquid crystal panel; the absorbing axis of the second polarizing plate PL2 is parallel to the initial alignment direction of the liquid crystal layer LC. According to the above relations between the alignment axis of the liquid crystal layer LC and the polarizing axis of the upper and lower polarizing plate, the voltage-brightness characteristics of the normally black type liquid crystal display device is established, which displays black when the voltage is not applied while the transmittance increases when the voltage is applied.

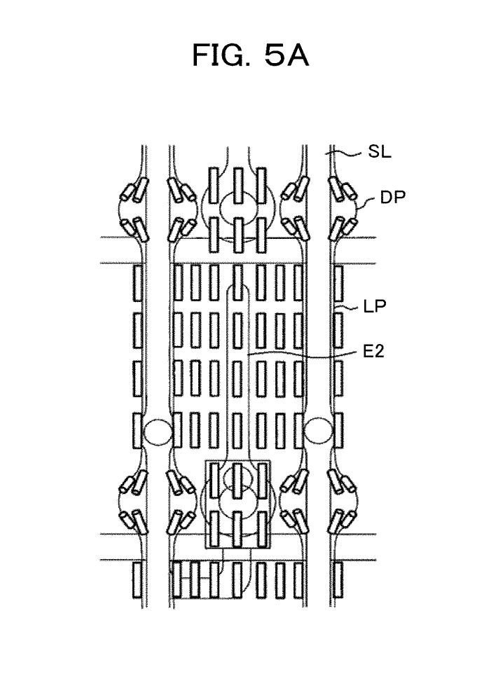

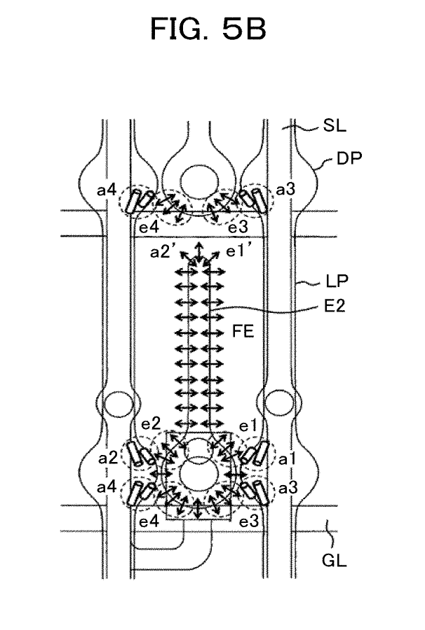

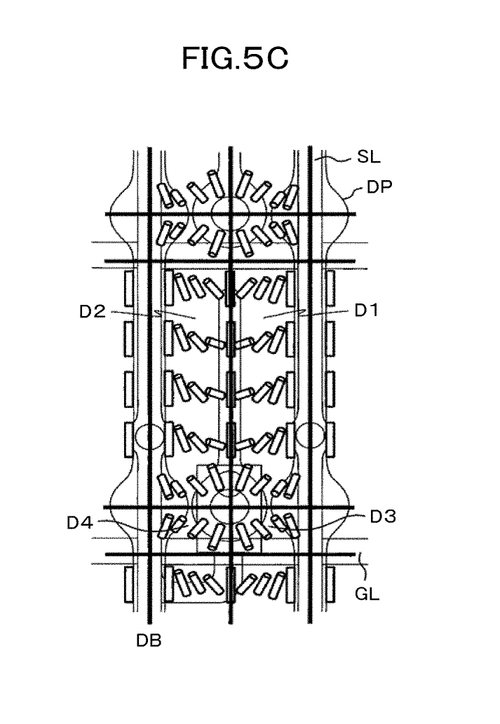

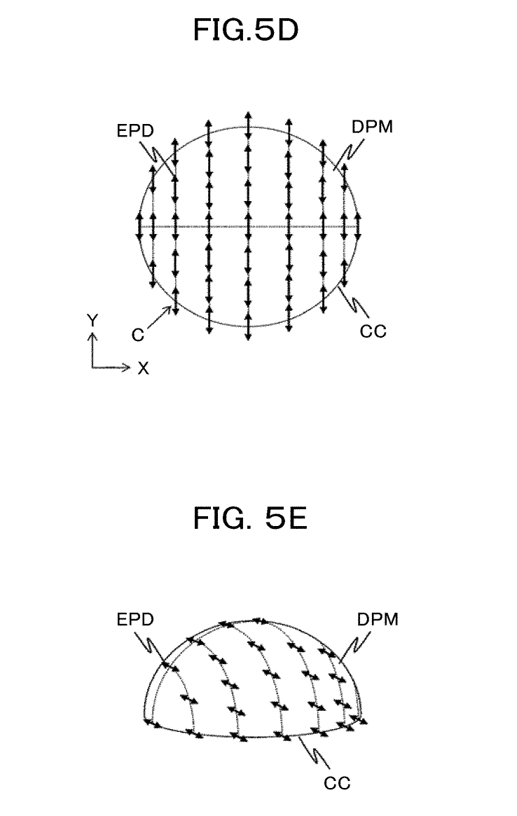

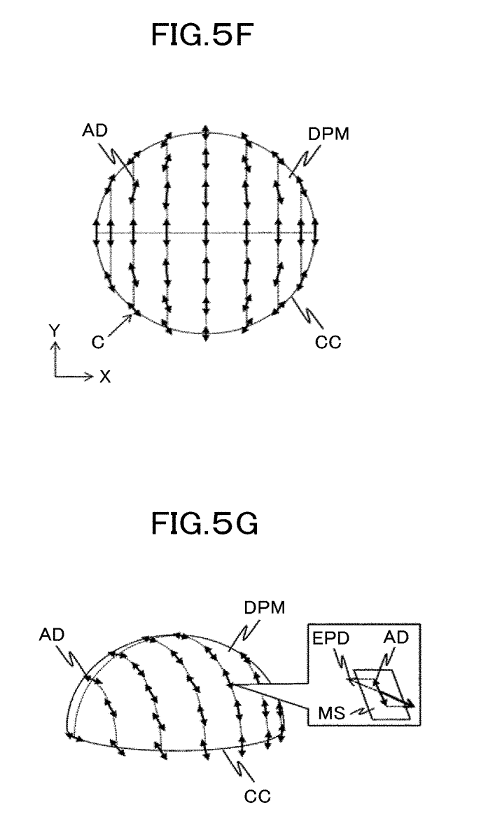

FIG. 5A discloses alignment of the liquid crystal layer LC in one pixel when no voltage is applied. The rods in FIG. 5a indicate local alignment directions of the liquid crystal layer LC, where the alignments are mostly parallel to the signal line SL; however, the alignment directions are not parallel to the signal line only at the domain fixing projection DP. The domain fixing projection DP is a circle of a diameter of 4.6 μm in a plan view, trapezoidal in cross sectional view; a thickness of 1.0 μm at the top and have a slope around the top.

FIGS. 5D to 5G are hemisphere DPM models for explanation of optical alignment process at the domain fixing projection DP. FIG. 5D is a plan view of the hemisphere DPM viewed from the normal direction to the major surface of the substrate; Y direction is the extending direction of the signal line SL, which is perpendicular direction to the vibration direction of the polarized ultra violet ray (herein after perpendicular to the vibration direction). By the way, when the polarized UV ray is irradiated in the normal direction to the alignment film formed in plane, the liquid crystal molecules aligns in a direction perpendicular to the vibration direction of the polarized UV ray. It is explained as that the high polymer chains that constitute the alignment film are cut in the direction parallel to the vibration direction of the polarized UV ray; thus, the polymer chains that are perpendicular to the vibration direction of the UV ray remain without cut. If the irradiation direction of the polarized UV ray is in a normal direction to the alignment film, the perpendicular direction to the vibration direction becomes initial alignment direction in a realignment process in the heating process, which is applied later.

The arrows EPD in FIG. 5D indicate the vibration directions of the polarized UV ray at the micro planes on the hemisphere DPM. Since the uniform polarized UV ray is irradiated on the hemisphere DPM, the direction EPD perpendicular to the vibration direction has the same azimuth on the hemisphere DPM as depicted in FIG. 5D. FIG. 5E is a perspective view that the hemisphere and the direction EPD perpendicular to the vibration direction is seen in a direction of arrow C in FIG. 5D. The direction EPD perpendicular to the vibration direction tilts to the corresponding micro plane; when tilt angle is defined as a tilt of the direction EPD perpendicular to the vibration direction against the micro plane, the tilt angle is zero at the top of the hemisphere DPM and increases in going to lower direction; it becomes 90 degree at the peripheral circle CC as depicted in FIG. 5E.

On the curved surface of the hemisphere DPM, the polarized UV light is irradiated in an oblique angle to the normal direction of the micro plane; therefore, the initial alignment direction deviates from the direction EPD perpendicular to the vibration direction. FIG. 5F corresponds to FIG. 5D, FIG. 5G corresponds to FIG. 5E, after baking; the arrows AD in FIGS. 5F and 5G indicate the initial alignment directions on the hemisphere DPM after the baking process. As depicted in FIG. 5G, the initial alignment directions AD distribute so as to align with the spherical surface of the hemisphere DPM, consequently, the tilt angles corresponding to the micro planes become zero. If the tilt angle of the direction EPD perpendicular to the vibration direction of the UV ray is not zero, the chain of the high polymer tilts against the micro plane, consequently it becomes unstable. The chains of high polymer change their alignment directions during the baking process to become parallel to the micro plane; as a result, the initial alignment directions AD become parallel to micro planes. Concretely, as depicted in the enlarged view in FIG. 5G, the projection of the direction EPD, which is perpendicular to the vibration direction of the UV ray, on the micro plane MS becomes the initial alignment direction. If FIG. 5G is observed from above, it becomes as FIG. 5F; wherein the initial alignment directions on the hemisphere DPM are not in the same direction, but distribute to align with peripheral circle CC of the hemisphere DPM.

If azimuth of the signal line SL is defined zero, the angle between the direction perpendicular to the vibration direction and the initial alignment direction become maximum when the azimuth angle is 45 degree or 135 degree, which is depicted by the arrow C in FIG. 5F. In the meantime, when a sloping angle of the micro plane at the curved surface is observed, an angle between the direction perpendicular to the vibration direction and the initial alignment direction becomes bigger according to the sloping angle becomes bigger.

On the other hand, if the height in the hemisphere DPM and the circumference CC are constant, the area of the slope becomes less according to the angle of the slope becomes bigger. Consequently, if the sloping angle is set including 45 degree, for example, 30 degree to 60 degree, the size of an angle between the direction perpendicular to the vibration direction and the initial alignment direction, and the area where the angle between the direction perpendicular to the vibration direction and the initial alignment direction is maintained big, can be balanced; thus, the domain fixing projection DP can have enough influence to the alignment status of nearby liquid crystals. By the way, the angle of the slope can be measured at the middle of the thickness direction of the domain fixing projection DP.

As described above, the initial alignment direction is not parallel to the signal line SL at the domain fixing projection DP; however, transmittance in black display can be suppressed by covering this portion by the black matrix BM formed on the first substrate SU1. The line shaped projection LP and the domain fixing projection DP are made of light sensitive transparent organic film in this embodiment; the light sensitive transparent organic film becomes a trapezoidal shape in cross section when it is developed. For the purpose to maintain this structure, intermediate baking of e.g. 100 centigrade, 10 minutes can be applied before the final baking of e.g. 230 centigrade, 30 minutes is applied.

If the normal direction to the slope is parallel to the alignment direction when viewed in normal direction to the substrate, the alignment direction doesn't deviate even on the slope. Since the line shaped projection LP is parallel to the alignment direction, as described in FIG. 5A, the alignment direction doesn't deviate on the line shaped projection LP. At the domain fixing projection DP, the deviation of the alignment direction doesn't occur at the place where the direction of the tangential of the circle is in upper direction or in bottom direction; the deviation occur where the tangential of the circle is in a tilting direction.

FIG. 5B depicts the alignment status on the domain fixing projection DP and the directions of fringe electric field FE when the voltage is applied. The fringe electric field FE is formed at the periphery of the second electrode E2; the alignment direction is parallel to the extending portion ET, therefore, the fringe electric field is generated just perpendicular to the alignment direction in the extending portion ET. Consequently, the alignment direction is unstable where the rotation in a clock wise and the rotation in a counter clock wise balance; thus, the change of alignment direction is determined by an environmental influence. The environmental influence means the initial alignment status at the domain fixing projection DP and the alignment status at the domain fixing structure DE when the voltage is applied; wherein when the alignments of those alignment statuses propagate, the liquid crystals change their alignment in the same direction.

On the other hand, the fringe electric field FE is formed in perpendicular to its edge at the periphery of the electrode; therefore, the direction of fringe electric field FE changes at the domain fixing structure DE along its periphery. The fringe electric field is parallel or perpendicular to the initial alignment direction at the left side, the right side and the bottom side of the domain fixing structure DE, consequently the alignment of the liquid crystal molecules becomes unstable as the same in the extending portion of the second electrode E2. In other places, the liquid crystal layer LC aligns according to the fringe electric field.

When the fringe electric field FE on the domain fixing structure DE is classified into e1, e1′, e2, e2′, e3, e4; and when the alignment direction on the domain fixing projection DP is classified into a1, a2, a3, a4 as depicted in FIG. 5B; e3 and a3 are in vicinity to each other and the directions are approximately the same. Since the liquid crystal LC in this embodiment has a positive dielectric anisotropy as described before, the liquid crystal LC changes its alignment direction according to the fringe electric field FE. Therefore, the liquid crystal in the area sandwiched between e3 and a3 change their alignments in the directions determined by e3 and a3 when the field is applied.

As the same token, e4 and a4 are in vicinity to each other and align approximately in the same direction; therefore, the liquid crystal LC changes is alignment in the direction specified by e4 and a4 in the area sandwiched by e4 and a4 when the voltage is applied. Even e1 and a1 is a little bit apart from e1′, the directions are approximately the same, the liquid crystal LC changes is alignment in the direction specified by e1, a1 and e1′ in the area sandwiched by e1, a1 and e1′ when the voltage is applied. The situation is the same in the area surrounded by e2, a2 and e2′.

FIG. 5C depicts the alignment of the liquid crystal layer LC when the voltage is applied; it further shows the status that: the initial alignments at the domain fixing projection DP and the alignments at the domain fixing structure DE when the voltage is applied have influenced all area of one pixel. The thick lines depict the domain boundary DP; the liquid crystal LC changes the alignment direction by rotating in the same direction in the area surrounded by the thick lines; thus forming the domain.

The thick lines distribute in the pixel and at the boundary of pixels; two thick lines exist in the pixel, one is parallel to the signal line SL and another is parallel to the scan line GL. The thick line parallel to the signal line SL exists at the center of the pixel and goes through on the second electrode E2; the thick line parallel to the scan line GL exists apart from the center of the pixel and goes through on the contact hole CH.

When the areas surrounded by thick lines are named as the first domain D1 through fourth domain D4 as depicted in FIG. 5C, a change of alignment direction by the clock wise rotation occurs in the first domain D1 and in the fourth domain D4, while the counter clock wise rotation occurs in the second domain D1 and in the third domain D3. As described above, domains that divide the pixel into four regions appear; however, domains don't divide the pixel in equal; the first domain D1 and the second domain D2 are rather bigger and the third domain D3 and the fourth domain D4 are rather smaller.

At the tip of the second electrode E2, the acute angle has disappeared; thus the tip is rounded; the right half region belongs to the first domain D1 and the left half region belongs to the second domain D2. Even in this area, a fringe electric field, e1′ and e2, oblique to the alignment directions of the liquid crystal layer LC is generated; the direction is the same as the tilting direction at the domain fixing structure DE, and further, the same as the tilting direction of the initial alignment direction at the domain fixing projection DP in the same pixel. Therefore, the tip TP of the second electrode E2 also contributes to the stability of the first domain D1 and the second domain D2.

In the meantime, the first domain D1 and second domain D2 are in the display portion of the pixel; the third domain D3 and fourth domain D4 are in the non-display portion of the pixel. The domain boundary is a dark line because the alignment of the liquid crystal layer LC does not change between when the voltage is applied and when the voltage is not applied; in the present invention, however, the dark line that appears in the display portion is only one, which is a boundary between the first domain D1 and the second domain D2, while the other dark line can be disposed in the non-display portion.

The alignment of the liquid crystal LC in the third domain and in the fourth domain are strongly regulated because the distance between the domain fixing projection DP and the domain fixing structure DE is short, further, a propagation of the alignment into the first domain D1 and the second domain D2 is suppressed by the domain fixing projection DP and the domain fixing structure DE. In addition a propagation of the alignment into the first domain D1 and the second domain D2 into the adjacent pixel is suppressed by the fringe electric field e1′ and e2′. Even when the adjacent pixel is in a dark state, the third domain and the fourth domain remain in the area that is shielded by the black matrix BM formed on the first substrate. Namely, the liquid crystal layer LC in the adjacent pixel is not in non-equilibrium state, the propagation of the third domain D3 and the fourth domain D4 is suppressed by the alignment regulating force by the first alignment film AL1 and the second alignment film AL2.

A twist alignment is generated when a change of alignment by the field is viewed in a thickness direction in the liquid crystal layer. However, when the alignment status in the first domain D1 is observed in detail in FIG. 5C, the change of alignment direction from the initial alignment is big at the vicinity of the fringe electric field FE, while the change of alignment direction from the initial alignment is small at the line shaped projection LP. The direction of the alignment changes from fringe electric field area to the line shaped projection LP; thus, the splay deformation is generated. Therefore, a ratio of the splay deformation in the elastic constant effectively increases; consequently, an apparent elastic constant increases. Above explained phenomenon is the same in the second domain D2, too.

The line shaped projection LP has a structure extending in the initial alignment direction of the liquid crystal molecules, therefore, the alignment regulating force in the initial alignment direction is reinforced at the vicinity of the line shaped projection LP. In addition, the thickness of the liquid crystal layer LC is decreased, thus, rotation of the liquid crystal molecules is further suppressed. Therefore, the rotation of the liquid crystal molecules at the vicinity of the line shaped projection LP is slight because the electric field is low and in addition because the alignment regulating force is reinforced.

The width of the extending portion ET of the second electrode E2 is set constant in FIG. 3A; if the width is set at the minimum working size, the width of the dark line that appears between the first domain D1 and the second domain D2 can be decreased. Since the dark line between the first domain D1 and the second domain D2 exists in the display portion as described before, the transmittance can be increased. If the thickness of the forth insulating film IL4 is decreased at the same time the width of the extending portion ET is decreased, the electric field applied the liquid crystal layer LC can be maintained. In concrete, this situation is attainable by making the ratio between the width of the extending portion ET of the second electrode E2 and the thickness of the fourth insulating film IL4 constant, for example, 10 to 40 is preferable.

As another measure, the width of the extending portion ET can be increased in going from the tip TP to the proximal edge to the domain fixing structure DE as depicted in FIG. 3B. The right hand side of the extending portion ET belongs to the first domain D1 and the left hand side of the extending portion ET belongs to the second domain D1; in this case, the direction of the fringe electric field EF becomes oblique to the initial alignment direction of the liquid crystal layer LC. Therefore, the fringe electric field FE also impacts to the change of the alignment of the liquid crystal layer LC, further, the direction of the fringe electrode field FE is the same as the direction that is determined by the domain fixing structure DE and domain fixing projection DP; consequently, the first domain D1 and the second domain D2 are further stabilized.

In this embodiment, the photo sensitive transparent organic film is used for the line shaped projection LP and the domain fixing projection DP; however, the black photo resist can be used for the line shaped projection LP and the domain fixing projection DP. In this case, the line shaped projection LP absorbs the light reflected from the signal line SL; thus, a display of high contrast can be maintained even in the bright environment in outdoors under the clear sky.

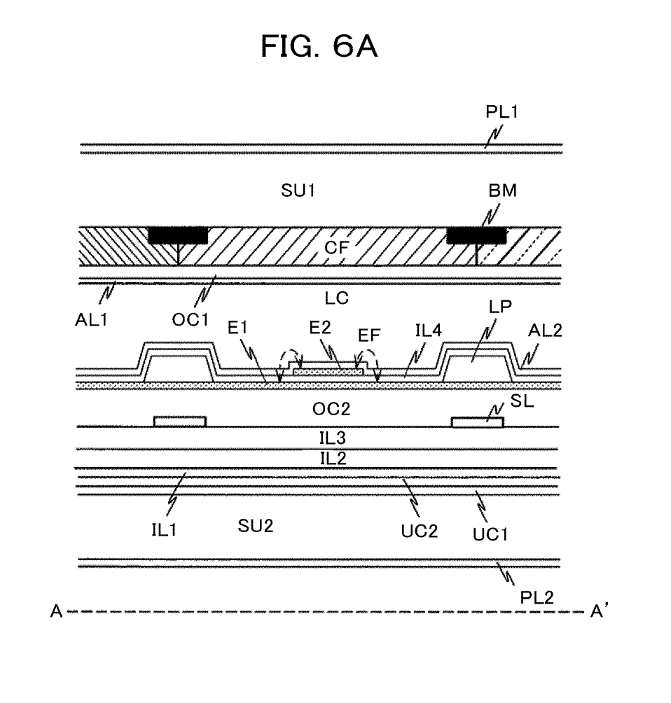

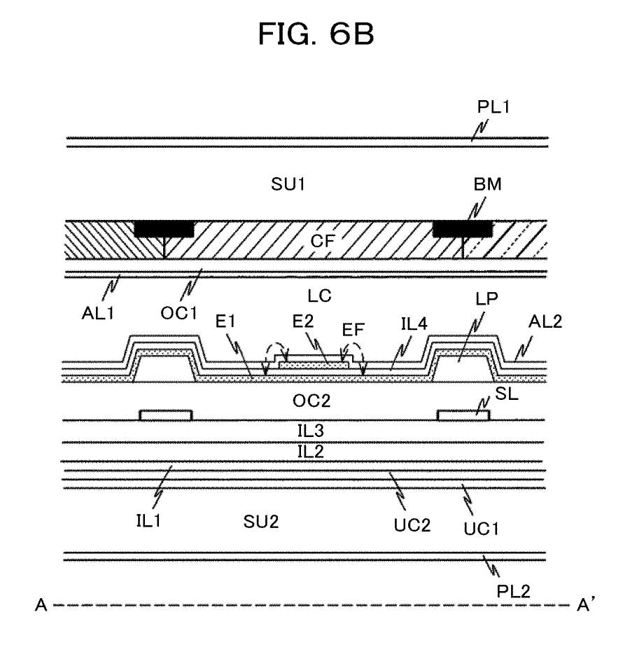

The line shaped projection LP and the domain fixing projection DP are proximate to the liquid crystal layer LC via the second alignment film AL2, as depicted in FIGS. 4A and 4B; therefore, when they are formed by the black photoresist, there is a chance that the pigments in the photo resin can influence to the liquid crystal layer LC. In counter measuring this phenomenon, the line shaped projection LP and the domain fixing projection DP can change their laminating order, and can be formed between the fourth insulating film IL4 and the first electrode E1 as depicted in FIG. 6A, for example.

Since the fourth insulating film IL4, which is formed by inorganic film, doesn't make unevenness of the under layer flat, the line shaped projection LP and the domain fixing projection DP, which are enlarged in widths by a thickness of the fourth insulating film IL4, are formed on the fourth insulating film IL4; thus, they can control the alignments of the liquid crystal layer LC as the same as described before.

As another measure, as depicted in FIG. 6B, the line shaped projection LP and the domain fixing projection DP can be formed between the first electrode E1 and the second flattening film OC2. The fourth insulating film IL4 and the first electrode E1 are formed by organic films; thus, as the same token, the alignment of the liquid crystal layer LC can be regulated.

Further, the line shaped projection LP and the domain fixing projection DP can be formed by a laminated film of the black photo resist film and the metal film. In this case, if the metal film is formed so as to contact to the first electrode E1, the resistance of the first electrode E1 can be decreased, thus, the delay of the common voltage, which is applied to the first electrode E1, can be avoided. In addition to that, since the black photo resist is located above the metal film, the light reflection by the metal film can be avoided by the black photo resist.

In forming the laminated film of the black photo resist and the metal, the black photo resist is patterned first, then, the metal film is patterned using the black photo resist film as the photo resist. Namely, the black photo resist film and the metal film can be fabricated in the same dimension; thus, the width of the laminated film of the black photo resist film and the metal film can be decreased. For example, the laminated metal film of molybdenum, aluminum, molybdenum can be used as the metal film.

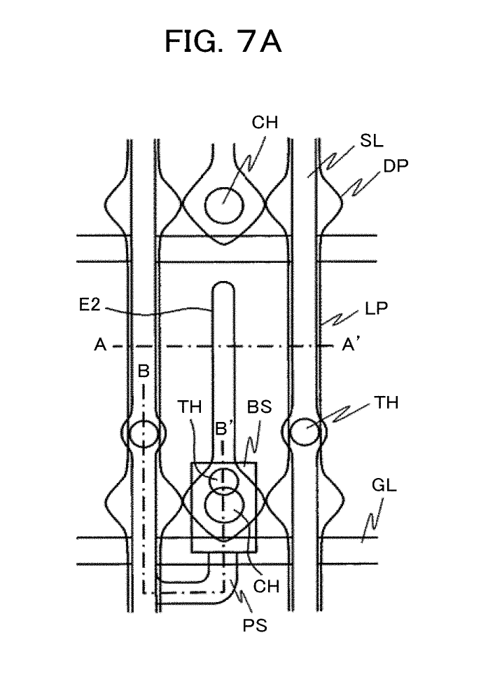

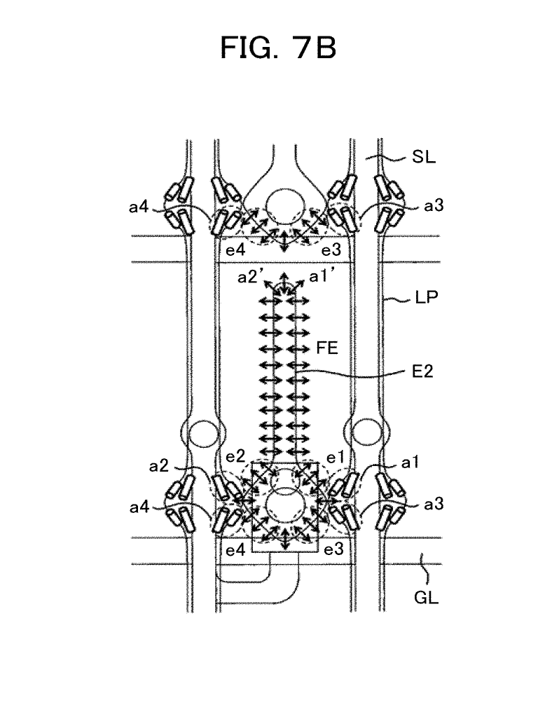

In FIG. 2, the domain fixing structure DE and the domain fixing projection DP are circle shaped; however, if more accurate manufacturing is possible, it is preferable to elongate the slanting portions in the structures. FIG. 7A is an example of the structures, the portions of azimuth of 45 degree and 135 degree of the domain fixing structure DE and domain fixing projection DP are elongated; thus, they become like diamond shape in a plan view.

As described above, the deviation from the photo alignment direction in the domain fixing projection DP is maximum at the azimuths of 45 degree and 135 degree, thus, the corresponding portions are enlarged; consequently, the effect to the alignment of the liquid crystal in the extending portion ET is reinforced. In addition, the domain boundary is formed as to go through on the portion where the circumference of the domain fixing structure DE and the domain fixing projection DP are parallel to or perpendicular to the alignment of the liquid crystal; since the portion of the parallel or the perpendicular is limited to the vicinity to the vertex of the diamond shape, the position the domain boundary is limited, consequently, the domain becomes stable.

FIG. 7B corresponds to FIG. 5B; FIG. 7B shows fringe electric field FE on the domain fixing structure DE and the alignment direction on the domain fixing projection DP. As depicted in FIG. 7B, the vertex of the diamond shaped domain fixing projection DP and the vertex of the diamond shaped domain fixing structure DE are closely located to each other.

Consequently, as in the example of relation between e1 and a1, the direction of the fringe electric field FE on the domain fixing structure DE and the alignment direction by the domain fixing projection DP are more aligned in the same direction; each of the alignment direction can be more strengthened and made more stable.

According to the above explained structure, the splay deformation is stably formed in the high definition display of 1000 ppi. Consequently, the display of high definition and high speed response display can be realized.

### Second Embodiment

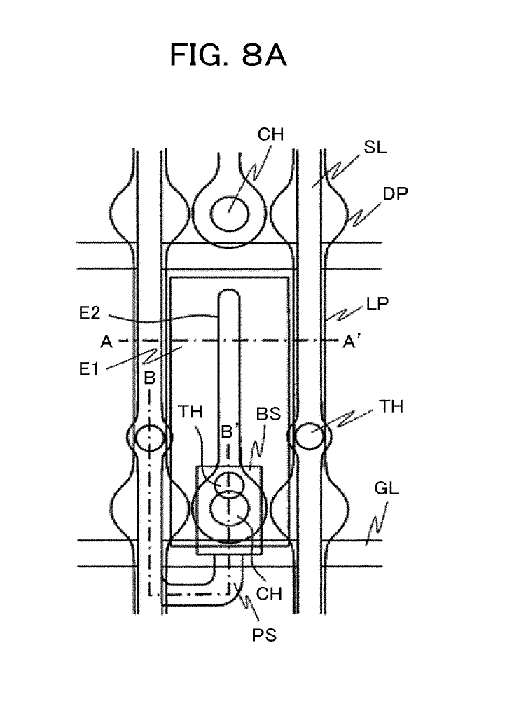

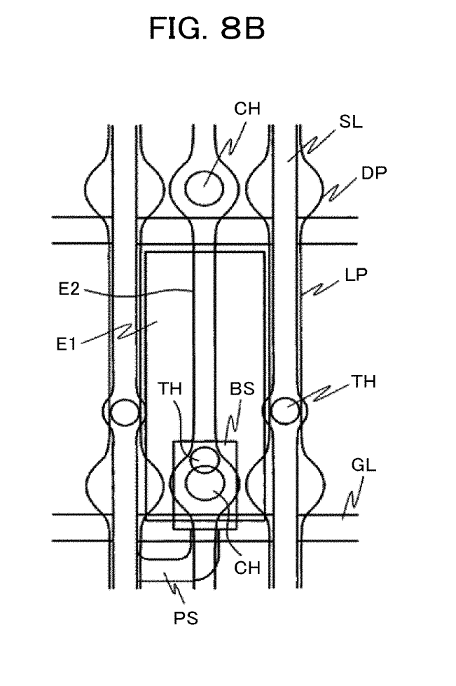

The liquid crystal display device according to the second embodiment differs from the first embodiment in that the pixel voltage is applied to the first electrode E1 and the common voltage is applied to the second electrode E2; accordingly, the shapes of the first electrode E1 and the second electrode E2 are made different. FIG. 8A shows plan views of the signal line SL, the scan line GL, the pedestal layer BS, the contact hole CH, the through hole TH, the first electrode E1, the second electrode E2, the line shaped projection LP, the domain fixing projection DP on the second substrate SU2.

The first electrode E1 is rectangle shaped and distributed in one pixel; the second electrode E2 is formed all over in plane shape and having a slit in one pixel; FIG. 8A depicts the slit of the second electrode E2. The silt of the second electrode E2 comprising the tip TP, the extending portion ET and domain fixing structure DE; the width of the domain fixing structure DE is wider than the width of the extending portion ET of the slit; the domain fixing structure DE is approximately circular in a plan view having the contact hole CH in it and concentric with the contact hole CH.

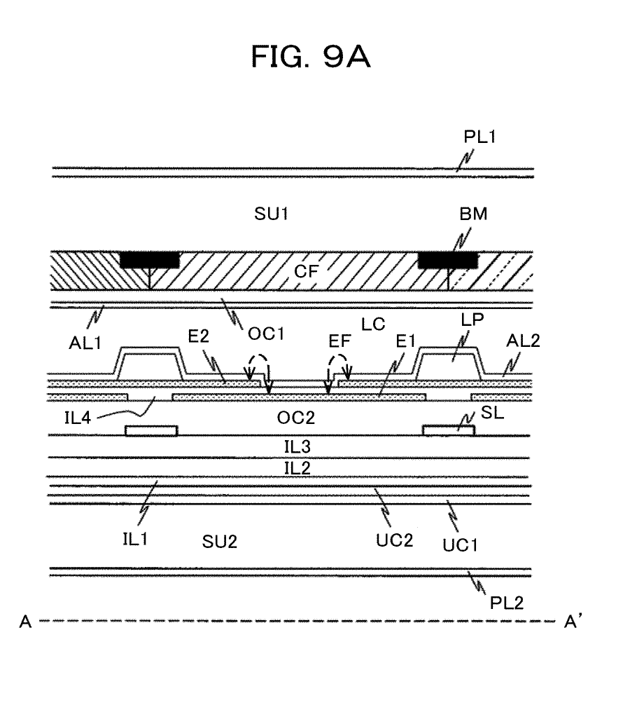

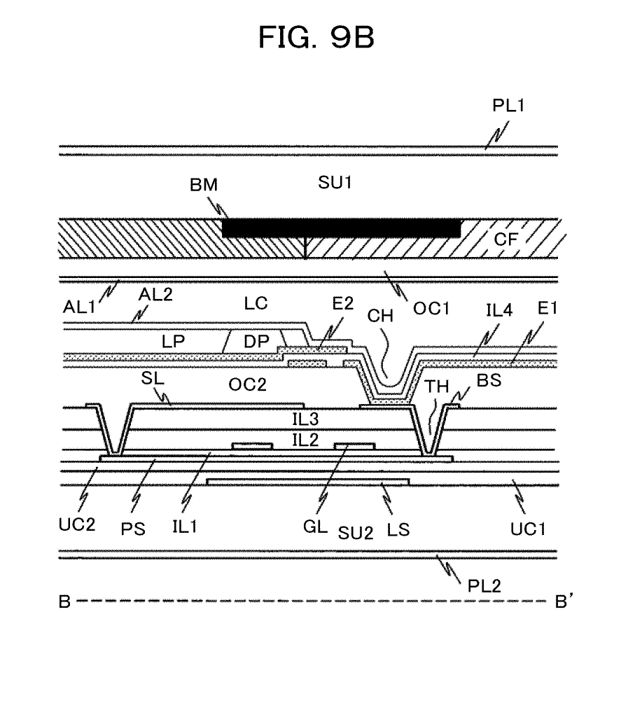

FIG. 9A is a cross sectional view along the line AA′ of FIG. 8A and FIG. 9B is a cross sectional view along the line BB′ of FIG. 8A. FIG. 9A is a cross section at the center of the pixel; FIG. 9B is a cross section including the thin film transistor. As depicted in FIG. 9B, the first electrode E1 is connected to the pedestal layer BS through the contact hole CH; the fourth insulating film IL4 covers the contact hole CH.

As depicted in FIG. 9A, the overlapping area of the first electrode E1 and the second electrode E2 is bigger compared with FIG. 4A; thus, the second embodiment has a bigger holding capacitance than that of the first embodiment. Consequently, voltage decrease in the liquid crystal layer is suppressed during the holding period, thus, display of less flicker can be realized. The fringe electric field, formed at the edge of the second electrode E2, drives the liquid crystal layer LC.

The planar distributions of the line shaped projection LP and the domain fixing projection DP of FIG. 9A are the same as in the first embodiment and the same distributions as in FIG. 2. Therefore, the initial alignment distribution is the same as in the first embodiment. Further, the distribution of the fringe electric field formed on the slit of the second electrode E2 when the voltage is applied is the same as that of FIG. 5B of the first embodiment, thus, the first domain D1, the second domain D2, the third domain D3 and fourth domain D4 are formed in one pixel.

In FIG. 8A, the width of the extending portion ET of the second electrode E2 is set constant; if the width is set at the minimum working size, the width of the dark line that appears between the first domain D1 and the second domain D2 can be decreased, consequently, the transmittance of the pixel can be increased. Further, if the width of the extending portion ET can be continuously increased in going from the tip TP to the proximal edge to the domain fixing structure DE, the first domain D1 and the second domain D2 can be further stabilized. The shape of the slit is the same as the circumference of the second electrode E2 in FIG. 3B.

The slit is confined in one pixel in FIG. 8A, however, the slit can be made continuous in pixels aligned in the direction of signal line SL as depicted in FIG. 8B. Namely, the common voltage is applied to the second electrode E2 in this embodiment, problem of e.g. short doesn't occur even when the slit is made continuous in the pixels in the longitudinal direction.

The position of the tip TP is tend to change according to the etching condition as over etching or under etching, when the second electrode E2 is patterned, however, if the tip TP is eliminated by making the slit continuous, the shape of the slit is stable irrespective of the etching condition; thus, uniform display can be made in the display area. Further, the slit can distributes up to an edge of the pixel; thus, the bigger area in one pixel is utilized for the driving the liquid crystal layer LC; consequently, the transmittance increases and the bright display can be realized.

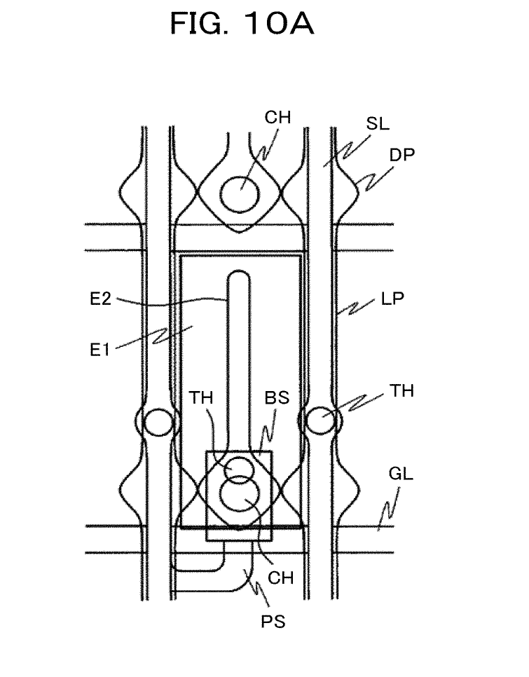

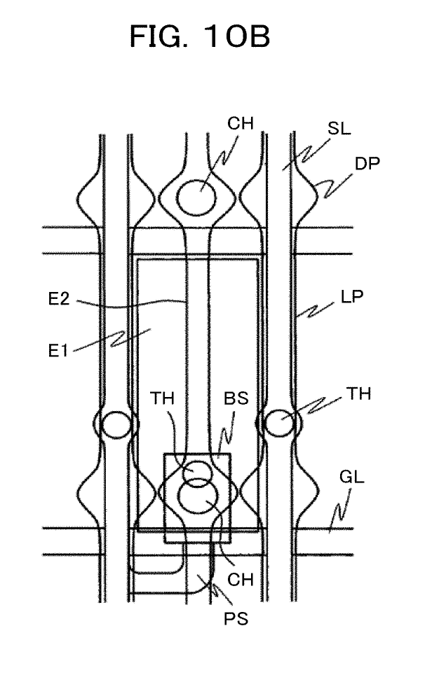

In addition to the light sensitive transparent organic film, the black photo resist can be used for the line shaped projection LP and the domain fixing projection DP; further, a lamination film of the black photo resin and the metal film can be used for the line shaped projection LP and the domain fixing projection DP. As depicted in FIG. 8A, the domain fixing projection DP and the domain fixing structure DE can be circle shaped in a plan view; however, if more accurate manufacturing is possible, it is preferable to elongate the slanting portions of them to make diamond shape as depicted in FIG. 10A; in this case the domain can be more stabilized. In this case, also, as depicted in FIG. 10B, the slit can be made continuously in the pixels that align in the direction of signal line SL.

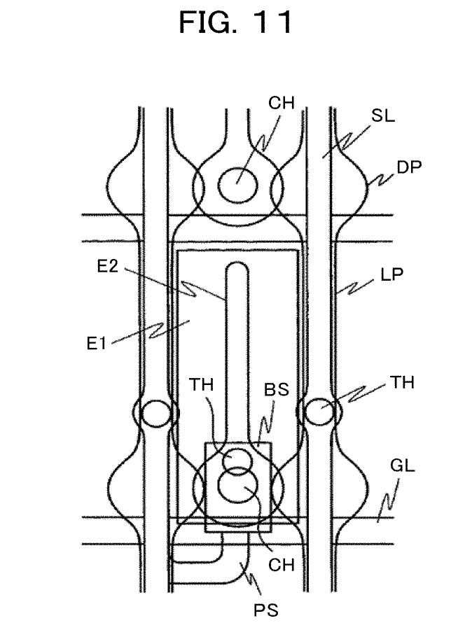

Further, the domain fixing structure DE and the domain fixing projection DP can overlap to each other as depicted in FIG. 11. Namely, since the domain fixing structure DE is covered by the fourth insulating film IL4, a short doesn't occur even when the domain fixing structure DE and the domain fixing projection DP overlap to each other. As a concrete manufacturing process, the domain fixing structure DE is formed expanding to the domain fixing projection DP first; then, the domain fixing projection DP is formed over the domain fixing structure DE. The slanting fringe electric field FE by the domain fixing structure DE is directly applied to the slanting initial alignment formed by the domain fixing projection DP; thus, alignment directions in the third domain D3 and the fourth domain D4 are firmly regulated; consequently, the third domain D3 and the fourth domain D4 are further stabilized.

### Third Embodiment

The liquid crystal display device according to the third embodiment differs from the second embodiment in that the fifth insulating film IL5 and the third electrode E3 are added between the first electrode E1 and the second flattening film OC2 of the second embodiment. The third electrode E3, which is made of ITO film, the same as the first electrode E1 and the second electrode E2, is supplied with the common voltage from the edge of the pixel. The fifth insulating film IL5 is SiN film which is formed by low temperature baking as the fourth insulating film IL4.

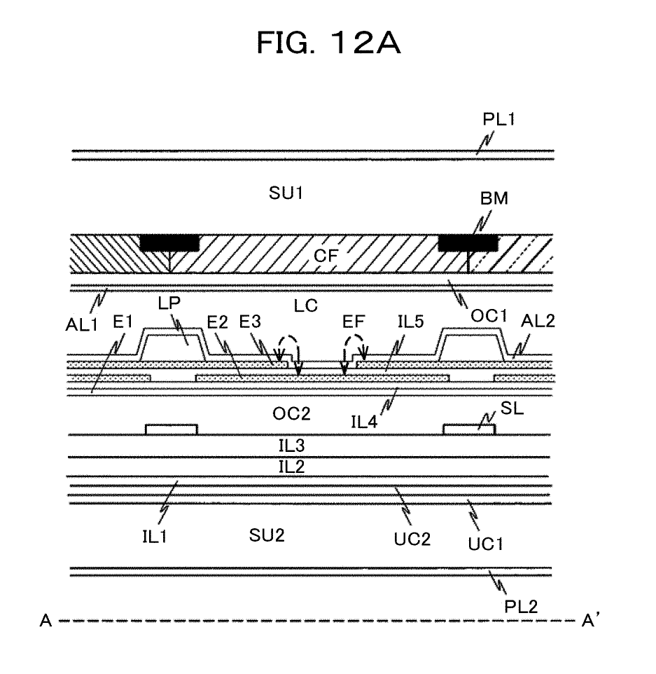

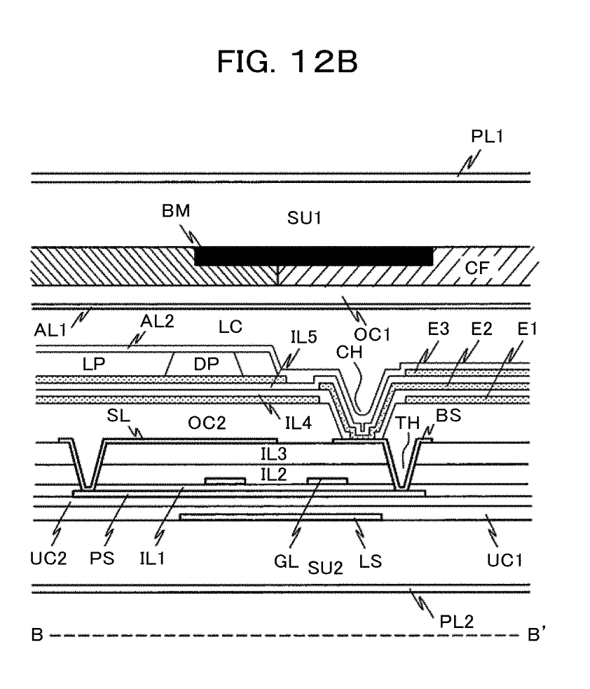

The planar distribution of the signal line SL, the scan line GL, contact hole CH, through hole TH, the first electrode E1, the second electrode E2, the line shaped projection LP and domain fixing projection DP on the second substrate SU2 in this embodiment are the same as FIG. 8A or FIG. 8B; FIG. 12A is a cross sectional view along AA′ line of FIG. 8A and FIG. 12B is a cross sectional view along BB′ line of FIG. 8A.

FIG. 12A is a cross section at the center of the pixel; FIG. 12B is a cross section including the thin film transistor. As depicted in FIG. 12B, the first electrode E1 has a hole around the contact hole CH; thus, the second electrode E2 is connected to the pedestal layer BS through the contact hole CH as the same in the second embodiment.

As depicted in FIG. 12A, the first electrode E1, which is applied with the common voltage, overlaps the second electrode E2, which is applied with the pixel voltage, from underneath, sandwiching the fourth insulating film IL4 between them. The third electrode E3, which is applied with the common voltage, overlaps the second electrode E2, which is applied with the pixel voltage, from above, sandwiching the fifth insulating film IL5 between them. Therefore, both of the overlapping portion between the first electrode E1 and the second electrode E2, and the overlapping portion between the second electrode E2 and the third electrode E3 work as the holding capacitance. The area of overlapping portion is bigger than the second embodiment; thus, bigger holding capacitance is formed, consequently, flickering is further suppressed.

### Fourth Embodiment

The liquid crystal display device according to the fourth embodiment differs from the third embodiment in that the color filter CF, which is on the first substrate SU1 in the third embodiment, is formed on the second substrate SU2 in the fourth embodiment. The red color filter RC, the green color filter GC and the blue color filter BC are periodically set in the lattice formed by the signal line SL and the scan line GL.

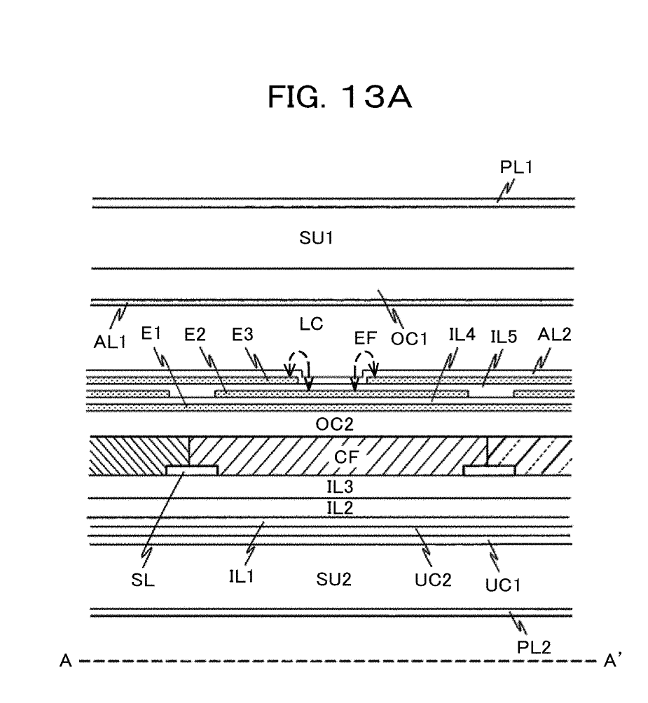

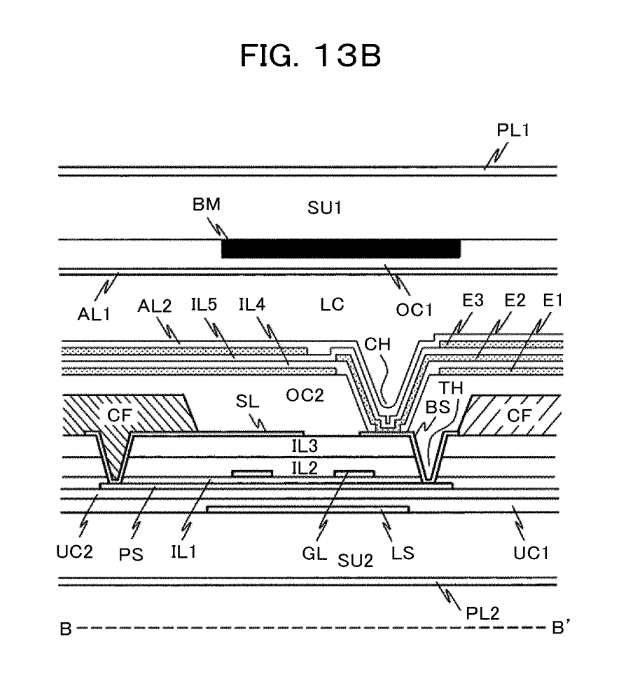

The planar distribution of the signal line SL, the scan line GL, contact hole CH, through hole TH, the first electrode E1, the second electrode E2, the line shaped projection LP and domain fixing projection DP on the second substrate SU2 in this embodiment are the same as FIG. 8A or FIG. 8B; FIG. 13A is a cross sectional view along AA′ line of FIG. 8A and FIG. 13B is a cross sectional view along BB′ line of FIG. 8A.

FIG. 13A is a cross section at the center of the pixel, FIG. 13B is a cross section including the thin film transistor. The first alignment film AL1, the first flattening film OC1 and the black matrix BM are formed from the side vicinity to the liquid crystal layer LC on the first substrate SU1. Comparing FIG. 3B with FIG. 13B, the feature of the present embodiment is that the color filter CF is added between the second flattening film OC2 and third insulating film IL3 on the second substrate SU2.

As described above, the liquid crystal display device according to the present embodiment is COA (Color Filter on Array) type, where the color filter CF is formed on the same substrate as the thin film transistor is formed; the COA has a merit that suppress the color mixture due to viewing angle. In the meantime, the color mixture is a specific phenomenon when a mono color is displayed in IPS type or FFS type liquid crystal display device; it is defined as the change of the color when the screen is observed changing polar angle including normal direction, in azimuthal direction parallel to the direction that the color filters CF are repeatedly arranged. When the color mixture due to viewing angle occurs, the color purity is deteriorated in the viewing angle, further, in severe case, the color itself changes.

In the liquid crystal display device, the pixel and the color filter CF are arranged to correspond to one to one; the light from the light source is designed to pass the paired pixel and color filter CF; such light is called matched light in this specification. On the other hand, there is a light pass where the light does not pass the paired pixel and color filter CF; such light is called unmatched light in this specification. The color mixture due to viewing angle occurs when the unmatched light becomes conspicuous.

Certain amount of the unmatched light exists at the edge of the pixel irrespective of the size of the pixel; in the screen of low definition, however, the color mixture was not conspicuous because the amount of matched light is overwhelming. In the screen of high definition, the amount of the matched light decreases while the amount of the unmatched light is constant; consequently, ratio of unmatched light increases according to the definition of the screen becomes higher.

As a result, the unmatched light becomes conspicuous and color mixture due to viewing angle occurs; it is explained as that: the width of the pixel is narrow in high definition screen, thus, the ratio of the deviation between the color filter CF and the pixel or the distance between the color filter CF and the pixel becomes bigger compared with the width of the pixel. The color filter CF is formed on the array substrate in COA (Color Filter on Array) type; thus, both of the deviations between the color filter CF and the pixel and the distance between the color filter CF and the pixel are decreased, consequently, the color mixture due to the viewing angle can be decreased.

The above explanation is made as a premise that the first substrate SU1 and the second substrate SU2 deviate as a whole to each other; however, according to the thickness of the substrate becomes thinner, a deformation in the substrate appears due to a stress in the manufacturing process, consequently, there is a chance that the first substrate and the second substrate locally deviate to each other. The COA type can decrease the color mixture due to viewing angle in either case. In the meantime, the display can be curved if the first substrate SU1 and the second substrate SU2 are formed by plastic like high heat resistant polyimide. In COA type, the pixel and the color filter CF don't deviate to each other even the screen is bent; thus, the curved surface display without color deviation and color mixture due to viewing angle can be realized.

### Fifth Embodiment

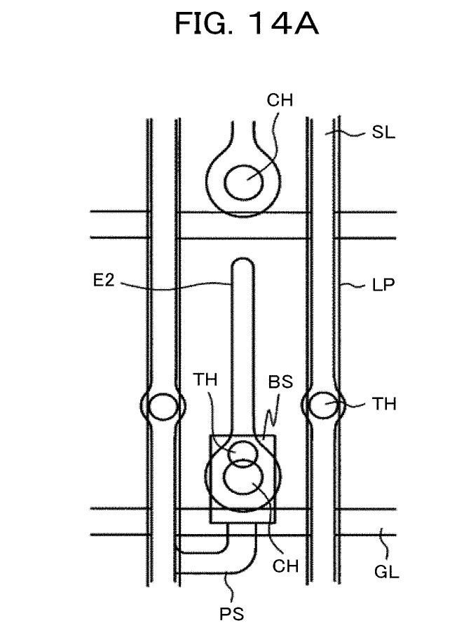

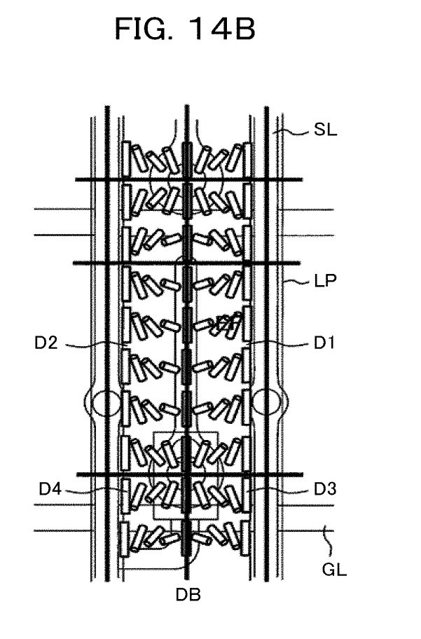

As depicted in FIG. 14A, the liquid crystal display device according to the fifth embodiment differs from the first embodiment in that: the domain fixing projection DP is eliminated and the line shaped projection LP is formed continuously in the longitudinal direction. Even in this case, the first domain D1, the second domain D2, the third domain D3 and the fourth domain D4 are formed in one pixel due to the influence of the domain fixing structure DE. The merit of the present invention can be enjoyed in certain degree even in this embodiment.

However, the domain boundary between the fourth domain D4 and the second domain D2 of the adjacent pixel is unstable because the domain boundary is made at the position where the propagation of the change of alignment due to the domain fixing structure DE of the subject pixel and the propagation of the change of alignment due to the domain fixing structure DE of the adjacent pixel compete. If the compete of the change of the alignments occurs at the intermediate position between the domain fixing structure DE of the subject pixel and the domain fixing structure DE of the adjacent pixel, the domain boundary is located near to the center of the pixel as depicted by thick line in FIG. 14B.

As the same token, the domain boundary between the third domain D3 and the first domain D1 of the adjacent pixel also is located near to the center of the portion of the pixel. As a result, the domain boundary DB parallel to the scan line GL is newly generated in the display portion as depicted in FIG. 14B, thus, it is observed as that brightness of the screen is decreased.

In addition, this domain boundary DB is unstable as that the position is changed from pixel to pixel due to a slight difference of the domain fixing structure DE in each pixels, further, the position of the domain boundary is changed by thermal fluctuation of the liquid crystal layer LC or by pressing force from outside. Movement of the domain boundary appears as non-uniformity of the transmittance, thus, irregularity in the screen appears in visual, further, change of color or decrease in color purity is observed.

The liquid crystal display device according to the first embodiment actually fixes the domain boundary by using the domain fixing projection DP and the domain fixing structure DE, not leaving the domain boundary to be formed at the position where the changes of the alignments of the liquid crystal layer LC compete to each other. Therefore, if the domain fixing projection DP is eliminated from the structure of the first embodiment, the domain boundary, existed on the domain fixing projection DP, becomes unstable and tends to locate at the display portion of the pixel. Therefore, the fifth embodiment has a danger of decrease of brightness of the screen or appearing irregularity in the screen compared with the structure of the first embodiment.

### Sixth Embodiment

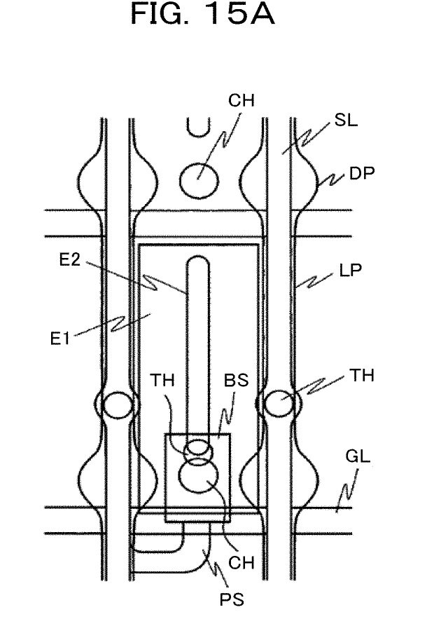

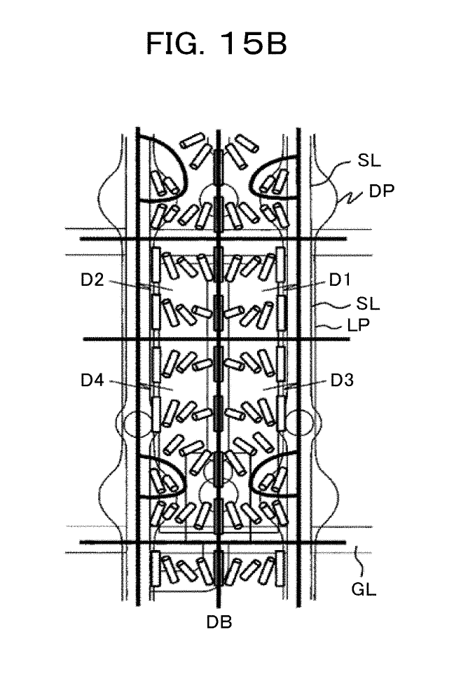

As depicted in FIG. 15A, the liquid crystal display device according to the sixth embodiment differs from the second embodiment in that the domain fixing structure DE is eliminated. In concrete, the width of the slit of the second electrode E2 is made uniform and the edge of the slit at the contact hole doesn't contain the contact hole CH in it; however, the slit is formed in the contact hole CH. As a result the slit has a tip at both ends. The tip at the same position as the second embodiment is called the first tip TP1 while the tip at the end of the side of the contact hole CH is called the second tip TP2. Even in this embodiment, a merit of the invention can be enjoyed in certain degree because of existence of the line shaped projection LP and the domain fixing projection DP.

The tip TP also generates the fringe electric field that aligns the liquid crystal layer LC in a slant direction; further the alignment direction by the first tip TP1 when the voltage is applied is the same as the initial alignment direction by the domain fixing projection DP. Similarly, the alignment direction by the second tip TP2 when the voltage is applied is the same as the initial alignment direction by the domain fixing projection DP; in this case, too, the first domain D1, the second domain D2, the third domain D3 and the fourth domain D4 are generated in one pixel as depicted in FIG. 15B.

Since the domain boundary between the second domain D2 and the fourth domain D4 is determined at the position where the propagation of the change of alignment due to the first tip TP1 and the propagation of the change of alignment due to the second tip TP2 compete, it exists e.g. at the middle point between the first tip T1 and the second tip T2. As the same token, the boundary between the first domain D1 and the third domain D3 exists at the middle point between the first tip T1 and the second tip T2. Therefore, the domain boundary parallel to the scan line GL is newly generated.

Since new dark line is generated in the display portion, a decrease in brightness of the screen is observed. The first tip TP1 and the second tip TP2 are apart to each other, thus, the position of the domain boundary is unstable; consequently, the boundary is formed in various positions among the pixels. As a result, irregularity in the screen appears in visual, further, change of color or decrease in color purity is observed.

As described above, if the domain fixing structure DE is eliminated, the domain boundary, existed on the domain fixing structure DE, becomes unstable and tends to locate at the display portion of the pixel. Therefore, the display quality of the sixth embodiment decreases compared with the display quality of the second embodiment.

### Seventh Embodiment

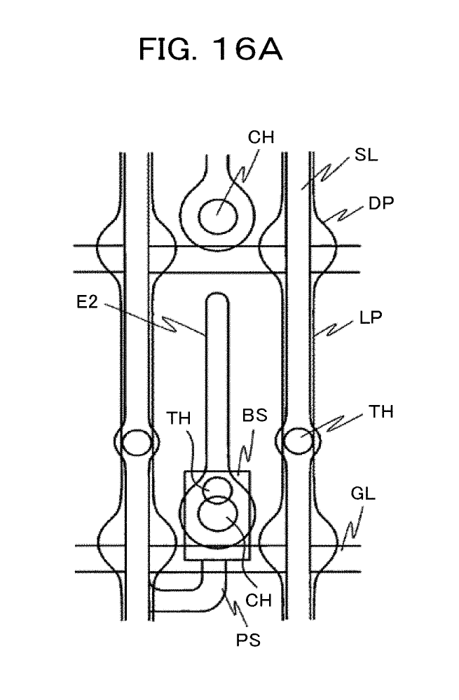

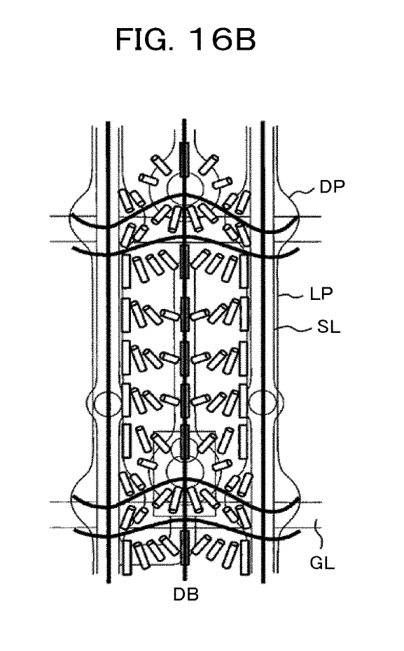

As depicted in FIG. 16A, the liquid crystal display device according to the seventh embodiment differs from the first embodiment in that the positions of the domain fixing structure DE and the domain fixing projection are changed; the domain fixing structure DE and the domain fixing projection DP are not aligned in line, but they are most proximate where the tangential of their circles obliquely cross with the signal line SL and the scan line GL. Even such structure, the merit of the present invention can be enjoyed in certain degree due to the existence of the line shaped projection LP and the domain fixing projection DP.

In this embodiment, however, the domain fixing structure DE and the domain fixing projection DP, which existed in proximate with each other in the first embodiment, deviate to each other; thus, the domain boundary does not become a straight line, which is the shortest line, but becomes curved line as depicted in FIG. 16B. Such domain boundary is unstable; the shape of the domain boundary easily changes due to thermal fluctuation of the liquid crystal layer LC or by pressing force from outside. The changes of the shape of the domain boundary are different among the pixels; thus, the distributions of the dark lines are also different among the pixels; consequently, irregularity in the screen is observed. Further, if the ratio of the transmittance is different from the video signal, the change of color or the decrease in color purity are observed.

The domain fixing structure DE and the domain fixing projection DP have a role to align the liquid crystal layer LC in a direction slant to the alignment direction of the alignment process; the domain fixing structure DE and the domain fixing projection DP are aligned in line in the liquid crystal display device of the first embodiment; thus, the slanting directions of alignments nearby are made consistent. However, when The domain fixing structure DE and the domain fixing projection DP are set deviated from in line, the initial alignment direction due to the domain fixing projection DP and the alignment direction due to fringe electric field when the voltage is applied to the domain fixing structure DE nearby become inconsistent. As a result, the domain boundary does not become shortest and it becomes unstable; consequently, the display quality decreases. Therefore, display characteristics of the seventh embodiment decreases compared with that of the first embodiment.

What is claimed is:

1. A liquid crystal display device comprising:
a first substrate having a plurality of scan lines extending in a first direction, a plurality of video signal lines extending in a second direction, which crosses the first direction, a pixel formed in an area surrounded by the video signal lines and the scan lines,
a second substrate opposing to the first substrate sandwiching a liquid crystal layer; wherein
the pixel includes a thin film transistor, a first electrode, a second electrode formed over the first electrode sandwiching an insulating film, a contact hole that connects the second electrode and the thin film transistor,
the second electrode has a first portion that extends in the second direction, and a second portion that is wider in the first direction than the first portion,
a first projection extending in the second direction is formed over the video signal line,
a second projection, which is wider than the first projection in the first direction, is formed over the video signal line, and
the second portion and the second projection are arranged in the first direction.

2. The liquid crystal display device according to claim 1,
wherein the second portion and the second projection are circle shaped in a plan view.

3. The liquid crystal display device according to claim 1,
wherein a center of the second portion and a center of the second projection are aligned in line in a plan view.

4. The liquid crystal display device according to claim 1,
wherein the second portion is a parallelogram in a plan view and having a first side that crosses in 45 degree with the first direction,
the second projection is a parallelogram in a plan view and having a second side that crosses in 45 degree with the first direction,
the second portion and the second projection are proximate at their vertexes.

5. The liquid crystal display device according to claim 1,
wherein the second electrode has a third portion that is opposite end to the second portion,
the third portion is arc in a plan view.

6. The liquid crystal display device according to claim 1,
wherein a width of the first portion of the second electrode in the first direction becomes wider in going from the third portion to the second portion.

7. The liquid crystal display device according to claim 1,
wherein the first projection and the second projection are formed by a light shielding film.

8. The liquid crystal display device according to claim 1,
wherein a color filter is formed between the first electrode and the second substrate.

9. A liquid crystal display device comprising:
a first substrate having a plurality of scan lines extending in a first direction, a plurality of video signal lines extending in a second direction, which crosses the first direction, a pixel formed in an area surrounded by the video signal lines and the scan lines,
a second substrate opposing to the first substrate sandwiching a liquid crystal layer; wherein
the pixel includes a thin film transistor, a first electrode, a second electrode formed over the first electrode sandwiching an insulating film, a contact hole that connects the second electrode and the thin film transistor,
the first electrode is formed in plane shape, the second electrode has a slit,
the slit has a first portion that extends in the second direction, and a second portion that is wider in the first direction than the first portion,
a first projection extending in the second direction over the video signal line, and
a second projection, which is wider than the first projection in the first direction, at the position nearer to the contact hole are formed.

10. The liquid crystal display device according to claim 9,
wherein the second portion of the slit is circle in a plan view, the second projection is circle in a plan view.

11. The liquid crystal display device according to claim 9,
wherein the second portion of the slit has a first side that crosses in 45 degree with the first direction,
the second projection has a second side that crosses in 45 degree with the first direction,
the first side and the second side oppose to each other.

12. The liquid crystal display device according to claim 9,
wherein the second portion is a parallelogram in a plan view and having a first side that crosses in 45 degree with the first direction,
the second projection is a parallelogram in a plan view and having a second side that crosses in 45 degree with the first direction,
the second portion and the second projection are proximate at their vertexes.

13. The liquid crystal display device according to claim 9,
wherein the slit has a third portion that is opposite end to the second portion,
the third portion is arc in a plan view.

14. The liquid crystal display device according to claim 9,
wherein a width of the first portion of the slit in the first direction becomes wider in going from the third portion to the second portion.

15. The liquid crystal display device according to claim 9,
wherein the first projection and the second projection are formed by a light shielding film.

16. The liquid crystal display device according to claim 9,
wherein a color filter is formed between the first electrode and the second substrate.

17. The liquid crystal display device according to claim 9,
wherein the slit is continuously made into an adjacent pixel in a lateral direction.

18. The liquid crystal display device according to claim 9,
wherein a third electrode is formed under the second electrode via a second insulating film, the voltage of the third electrode is the same as the first electrode.

19. The liquid crystal display device according to claim 1,
wherein the second projection has a side wall, the angle of the side wall is 30 degree to 60 degree.

20. The liquid crystal display device according to claim 1,
wherein an initial alignment direction of the liquid crystal is in the second direction.
